(19) United States
(12) Patent Application Publication
(10) Pub. No.: US 2002/0149270 A1
(43) Pub. Date: Oct. 17, 2002

(54) Planar electric motor with two sided magnet array

(76) Inventor: Andrew J. Hazelton, San Carlos, CA (US)

Correspondence Address: Barry E. Bretschneider, Morrison & Foerster LLP, Suite 5500, 2000 Pennsylvania Avenue, N.W., Washington, DC, 20006-1888, US

(21) Appl. No.: 09/832,906

(22) Filed: Apr. 12, 2001

(51) Int. Cl. H02K 41/00

(52) U.S. Cl. 310/12

(57) ABSTRACT

An electric motor comprising an upper coil array, a lower coil array and a magnet array movable relative to the coil arrays and interposed therebetween. The magnet array has an upper surface and a lower surface and comprises a plurality of wedge magnets disposed in a plane. Each wedge magnet has a magnetic polarity oriented at an angle relative to the plane. The magnets are arranged in groups, each group forming an upper resultant magnetic flux extending substantially perpendicular to the plane from said upper surface of the magnet array and a lower resultant magnetic flux extending substantially perpendicular to said plane from said lower surface of the magnet array. The upper coil array is operable to interact with the upper resultant magnetic flux and the lower coil array is operable to interact with the lower resultant magnetic flux to move the magnet array.

### FIELD OF THE INVENTION

This invention relates generally to electric motors, and more particularly, to high precision motors for use in lithography systems.

### BACKGROUND OF THE INVENTION

Many precision systems, such as those used in semiconductor manufacturing, use linear or planar motors for positioning objects such as semiconductor wafers. Conventional planar motors are disclosed in U.S. Pat. Nos. 3,851,196, 4,654,571, 5,196,745, and 5,334,892. These patents describe planar motors that have significant limitations. For example, the planar motor of the '196 patent has limited range of motion since each motor portion of the stationary magnet array can only generate force in a single direction. Thus, each coil array must always be located above the corresponding magnet array. This limits the range of movement for a given size actuator. The motor disclosed in the '745 patent similarly requires each coil array to be located above a corresponding linear magnet array. The motor of the '571 patent includes a coil design which generates only a limited amount of force due to the layout of the coils on the stage. In addition, the design does not generate force in six degrees of freedom. The '892 patent discloses a planar motor which permits a wide range of motion, but only in a single plane.

Conventional technology also relies upon cumbersome stacked arrangements to achieve six degrees of freedom of movement. These stacked arrangements have a number of drawbacks including additional power requirements, and reduced positioning accuracy. Motors which eliminate stacked arrangements and provide six degree of freedoms over a full range of movement of the wafer stage with a single planar motor require large magnet and coil arrays to provide the force required. This results in an increase in mass of the stage and system, thus reducing the natural frequency of the system and degrading performance.

There is, therefore, a need for a compact motor which provides six degrees of freedom with high speed and precision and energy efficient operation.

### SUMMARY OF THE INVENTION

The present invention overcomes the deficiencies of the prior art by providing a double sided magnet array for use in a planar electric motor. The magnet array is interposed between two coil arrays which can be independently driven or driven in conjunction with one another to move the magnet array to position a stage, for example. The double sided magnet array reduces the overall power required by the motor and allows for more efficient six degree movement of the stage than conventional motors. Moreover, this arrangement allows the stage to be supported at a nominal position between the two coil arrays with minimal or no power consumption.

A magnet array of the present invention is for use in a planar motor having two opposing coil arrays. The magnet array has an upper surface and a lower surface and comprises a plurality of wedge magnets disposed in a plane. Each wedge magnet has a magnetic polarity oriented at an angle relative to the plane. The magnets are arranged in groups, each group forming an upper resultant magnetic flux extending substantially perpendicular to the plane from the upper surface of the magnet array and a lower resultant magnetic flux extending substantially perpendicular to the plane from the lower surface of the magnet array.

In one embodiment the magnet array further comprises a plurality of transverse magnets each having a polarity oriented parallel to the plane. The transverse magnets are disposed between adjacent wedge magnet groups.

An electric motor of the present invention generally comprises an upper coil array, a lower coil array, and a magnet array movable relative to the upper and lower coil arrays and interposed therebetween. The magnet array has an upper surface and a lower surface and comprises a plurality of wedge magnets disposed in a plane. Each wedge magnet has a magnetic polarity oriented at an angle relative to the plane. The magnets are arranged in groups, each group forming an upper resultant magnetic flux extending substantially perpendicular to the plane from the upper surface of the magnet array and a lower resultant magnetic flux extending substantially perpendicular to the plane from the lower surface of the magnet array. The upper coil array is operable to interact with the upper resultant magnetic flux and the lower coil array is operable to interact with the lower resultant magnetic flux to move the magnet array relative to the coil arrays.

An exposure apparatus of the present invention generally comprises an irradiation system for irradiating an article with radiation to form a pattern on the article and a stage positioning device for positioning the article relative to the irradiation system. The stage positioning device comprises a stage movable relative to the irradiation system and adapted to support the article, an upper coil array, a lower coil array, and a magnet array attached to the stage. The magnet array has an upper surface and a lower surface and comprises a plurality of wedge magnets disposed in a plane. Each wedge magnet has a magnetic polarity oriented at an angle relative to the plane. The magnets are arranged in groups, each group forming an upper resultant magnetic flux extending substantially perpendicular to the plane from the upper surface of the magnet array and a lower resultant magnetic flux extending substantially perpendicular to said plane from said lower surface of the magnet array. The magnet array and stage are interposed between the upper and lower coil arrays. The upper coil array is operable to interact with the upper resultant flux and the lower coil array is operable to interact with the lower resultant magnetic flux to move the stage.

The above is a brief description of some deficiencies in the prior art and advantages of the present invention. Other features, advantages, and embodiments of the invention will be apparent to those skilled in the art from the following description, drawings, and claims.

### BRIEF DESCRIPTION OF THE DRAWINGS

FIG. 1 is an exploded view of an electric motor of the present invention;

FIG. 2 is a plan view of a coil array of the motor of FIG. 1;

FIG. 3 is a schematic of a magnet array of the motor of FIG. 1;

FIG. 3a is a schematic of an alternate magnet array of the motor of FIG. 1

FIG. 4 is a schematic showing one side of the magnet array of FIG. 3;

FIG. 5 diagrammatically illustrates the arrangement of wedge and transverse magnets in the magnet array of FIG. 4;

FIG. 6 is a plan view of the magnet array of FIG. 4 further showing the arrangement of the wedge magnets;

FIG. 7 is a side view of the magnet array of FIG. 4;

FIG. 8 is a plan view of an alternative embodiment of the magnet array of FIG. 3;

FIG. 9 is plan view of a coil of an alternative embodiment of the coil array of FIG. 2;

FIG. 10 is a side view of the coil of FIG. 9;

FIG. 11 is a perspective of the coil of FIG. 9;

FIG. 12 is a plan view of an alternative embodiment of the coil of FIG. 9;

FIG. 13 is a plan view of a row of the coils of FIG. 12;

FIG. 14 is an array of the coils of FIG. 12;

FIG. 15 is an alternative arrangement of the coils of FIG. 12; and

FIG. 16 is a schematic of a photolithography system with the electric motor of FIG. 1.

Corresponding reference characters indicate corresponding parts throughout the several views of the drawings.

### DESCRIPTION OF THE INVENTION

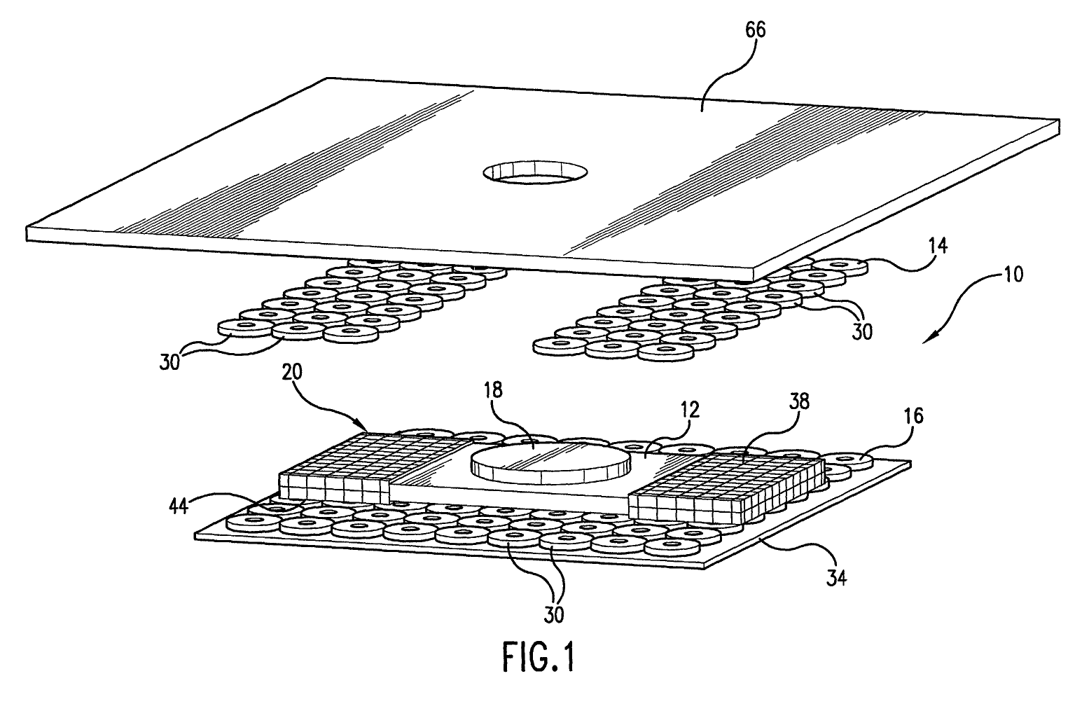

Referring now to the drawings, and first to FIG. 1, an electric motor of the present invention is generally indicated at 10. The motor 10 is for use in semiconductor processing, and more specifically photolithography systems. The electric motor 10 positions a stage 12 which is used to support a semiconductor wafer (not shown) during the photolithography process. The stage 12 includes a wafer chuck 18 for holding the wafer. The motor 10 uses electromagnetic force (Lorentz force) to propel a moving part such as the stage 12. The motor 10 comprises two coil arrays (upper and lower) 14, 16 positioned on opposite sides of the stage 12, and a magnet array, generally indicated at 20 attached to the stage. The magnet array 20 provides permanent magnetic fields and each coil array 14, 16 provides a current distribution. The current distribution of the coil arrays 14, 16 interact with the permanent magnetic fields extending from opposite sides of the magnet array 20 to cause a force between the magnet array and the coil arrays. The interaction of the magnetic fields and the current distribution permits the magnet array 20 to move with respect to the coil arrays 14, 16 in at least three degrees of movement and preferably six degrees of freedom.

Preferably, currents in the coil arrays 14, 16 interact with magnetic fields from the magnet array 20 to cause force in the X, Y, and Z directions, and torque about the X, Y, and Z directions between the coil arrays and the magnet array. This interaction and the general operation of a planar motor is described in U.S. patent application Ser. No. 09/192,813, by A. Hazelton et al., filed, Nov. 16, 1998, and U.S. patent application Ser. No. 09/135,624, by A. Hazelton, filed Aug. 17, 1998, the entirety of which are incorporated herein by reference.

As shown in FIG. 1, the magnet array 20 is attached to the stage 12 and is free to move with the stage relative to the coil arrays 14,16 which are in a stationary position. This moving magnet embodiment is preferred over a moving coil arrangement when used in positioning devices, because the magnet array 20 does not require electrical current connections. In addition, when coil cooling is required, cooling hoses must be attached to the coil arrays 14, 16. The electrical connections and cooling hoses may interfere with movement of a coil array.

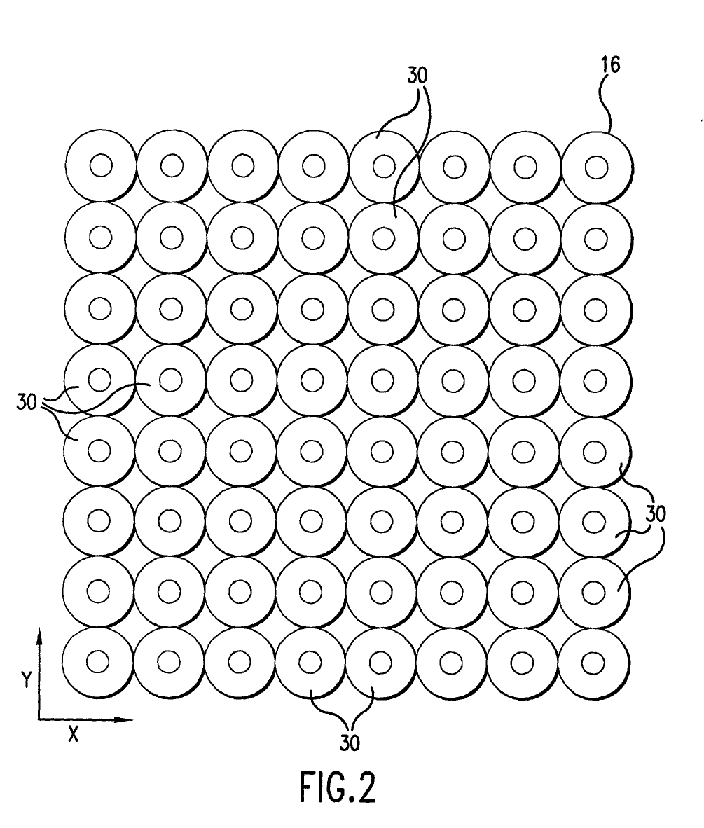

The lower coil array 16 includes a plurality of coils 30 periodically distributed in two directions (X and Y) and arranged in a rectangular pattern (FIG. 2). Preferably, the coils 30 all have the same shape and are evenly spaced in the X and Y directions. However, it is to be understood that the coils 30 may have different shapes, sizes, or arrangements than the one shown herein without departing from the scope of the invention. The coils 30 may have a toroidal shape as shown in FIG. 2, or an oval shape, for example. The coil array 16 is mounted on a backing panel 34 which comprises a magnetically permeable material, such as iron, or a magnetically impermeable material. The magnetically permeable backing panel 34 increases the permanent magnetic flux through the coils 30 and thus increases coil performance.

The upper coil array 14 includes a plurality of the coils 30 periodically distributed in two directions (X and Y) and arranged in a two dimensional array as are the coils of the lower coil array (FIGS. 1 and 2). The coil array 14 is mounted on a backing panel 66 which comprises a magnetically permeable material, such as iron, or a magnetically impermeable material. The only difference between the upper and lower coil arrays 14, 16 is that the upper coil array includes an opening to provide a path for light or an electron beam to pass through to expose the wafer positioned on the stage 12. The upper coil array 14 may be formed as two separate arrays as shown in FIG. 1, or as a continuous array with a central opening to provide a path between an optical system and the wafer. It is to be understood that the arrangement of the upper and lower coil arrays 14, 16 may be different than shown herein without departing from the scope of the invention. As shown in FIG. 1, the coils 30 of the upper and lower coil arrays 14, 16 are the same shape and size, however, the coils of each array may differ from one another in size or shape, for example.

As shown in FIG. 1, the magnet array 20 comprises two separate portions, each attached to one end of the stage 12, and interposed between the upper and lower coil arrays 14, 16. The magnet array 20 may be attached to the stage by adhesives or other suitable attachment means. Preferably, the magnet array 20 is bonded to the stage using epoxy. However, it can alternately or additionally be attached with a mechanical clamp, such as a bracket, and an accompanying bolt. The magnet array may also be positioned along one edge of the stage 12, three edges of the stage, or extend around the periphery of the stage.

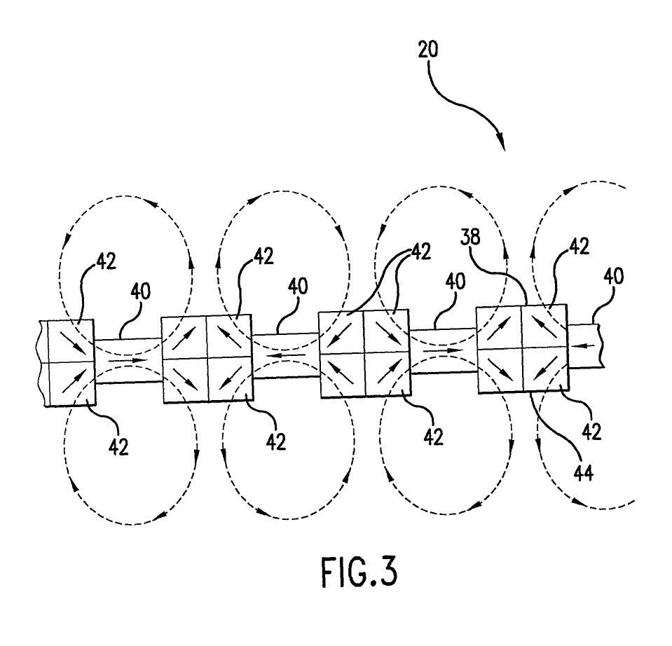

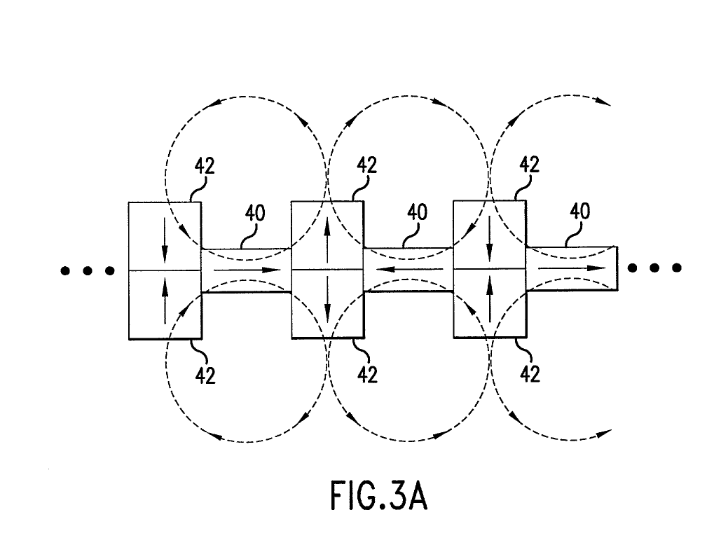

The magnet array 20 includes a plurality of magnets 40, 42 distributed in a first direction along an X axis and in a second direction along an Y axis to form a two-dimensional magnet array having an upper surface 38 and a lower surface 44 (FIGS. 1 and 3). The plurality of magnets 40, 42 are disposed in a reference plane (defined by the X and Y axes). The magnets are either transverse magnets 40 or wedge magnets 42. Generally, a wedge magnet 42 can be any permanent magnet having its polarization or magnetization direction at a non-zero, non-perpendicular angle with respect to a portion of its surface. Perpendicular angles are defined as 90 degrees plus or minus multiples of 180 degrees. Each wedge magnet 42 has a polarization at an acute angle (i.e., greater than zero degrees and less than ninety degrees with respect to the reference plane defined by the X axis and the Y axis). The wedge magnets 42 may have a high residual flux greater than 12,000 Gauss, for example.

It is possible for a wedge magnet to have its polarization or magnetization direction at a perpendicular angle with respect to a portion of its surface. In such a case, in this invention, multiple wedge magnets can be combined as shown in FIG. 3a. Acute angles (FIG. 3) are preferred for greater performance, whereas perpendicular angles (FIG. 3a) are preferred for lower cost.

The wedge magnets 42 are arranged in groups with each group creating an upper resultant magnetic flux extending substantially perpendicular to the reference plane from the upper surface 38 of the magnet array 20 and a lower resultant magnetic flux extending substantially perpendicular to the reference plane from the lower surface 44 of the magnet array.

The transverse magnets 40 are positioned between adjacent wedge magnet groups. The transverse magnet 40 has a polarity oriented generally parallel to the reference plane of the magnet array 20. The transverse magnets 40 link the magnetic flux from the upper and lower surfaces of the wedge magnets 42 to create a flux path between the wedge magnets and transverse magnets. Any leakage flux from one side of the magnet array 20 is coupled into the opposite side of the magnet array. As a result, the magnetic flux density to mass ratio is higher than that of a single sided magnet array. The estimated increase in useable magnetic flux is between 10% to 20%.

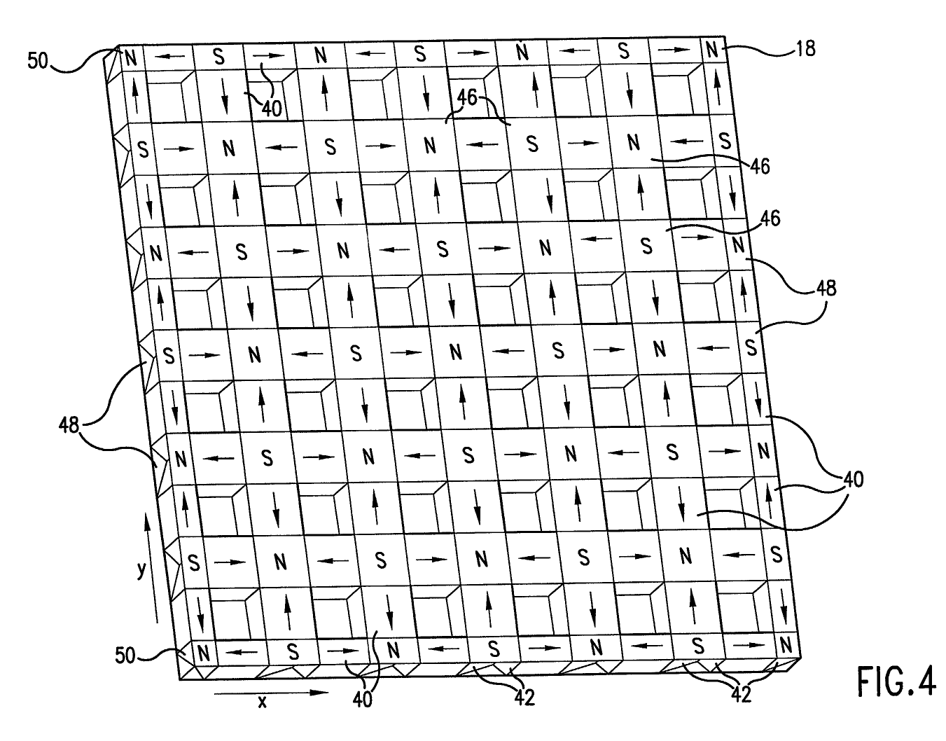

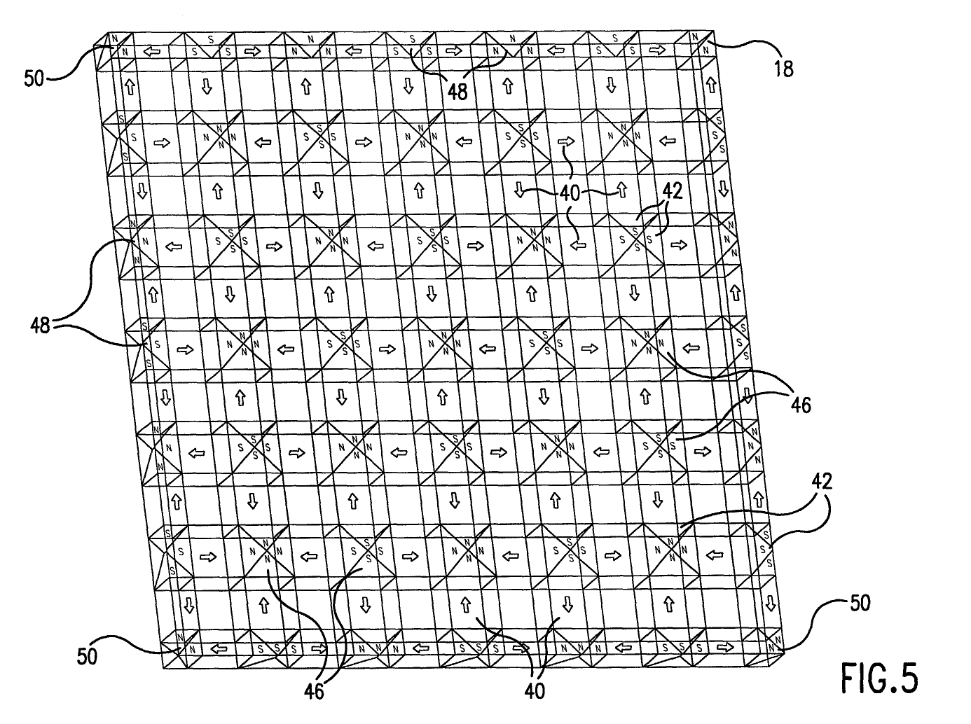

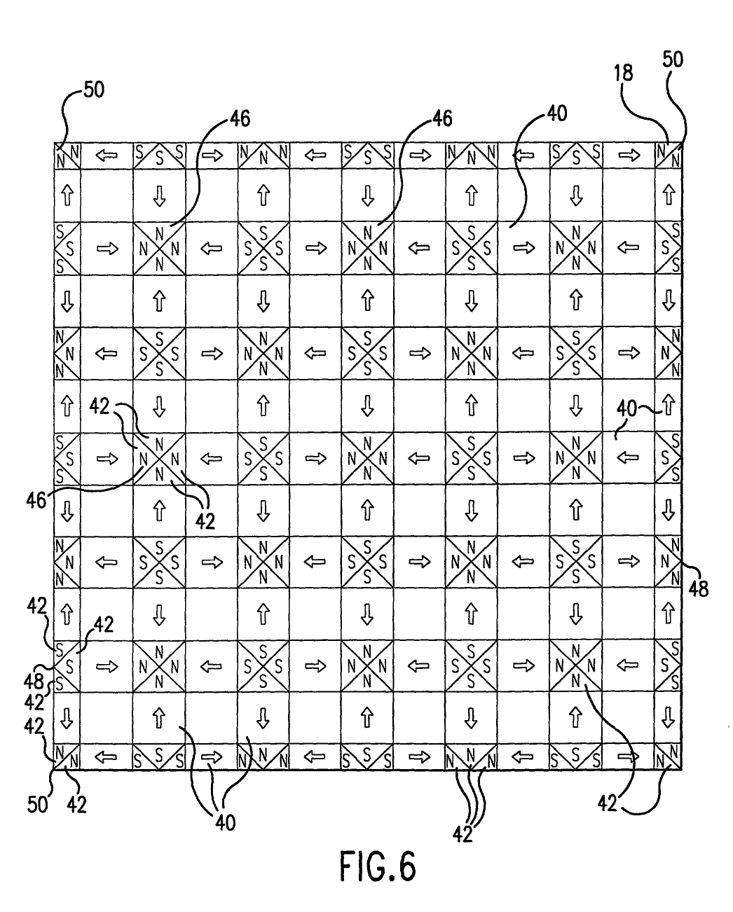

The arrangement and interaction of the transverse magnets 40 and wedge magnets 42 is described for a one sided magnet array in U.S. patent application Ser. No. 09/168,694, by Hazelton et al., filed on Oct. 5, 1998, which is incorporated herein by reference in its entirety. The following description with reference to FIGS. 4-7 is provided for one side of the magnet array for simplification.

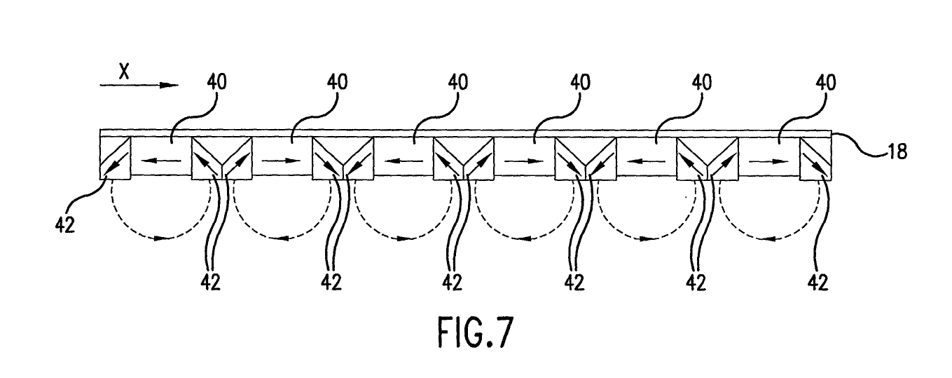

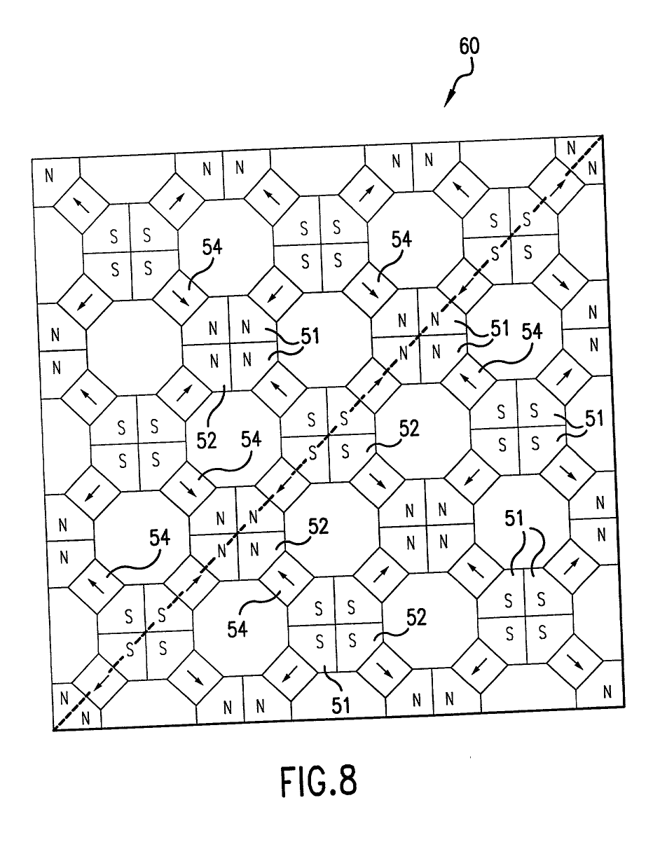

Interior wedge magnet groups 46 include four wedge magnets 42, exterior edge magnet groups 48 include three wedge magnets, and exterior corner wedge magnet groups 50 include two wedge magnets. The interior magnet groups 46 have approximately equal fluxes and alternate in polarity. The exterior edge magnet groups 48 have approximately half the flux of each interior magnet group 46 and corner magnet groups 50 have approximately one-quarter the magnetic flux of each interior magnet group. The transverse magnets 40 have polarities parallel to the surface defined by the X and Y axes and are placed between wedge magnet groups to complete flux paths (FIG. 7). With the wedge magnets 42 arranged as shown in FIG. 8, their respective magnetic fluxes combine to form a resultant magnetic flux in a direction perpendicular to the X and Y axes. The combination of the wedge magnets 42 in the magnet groups and the transverse magnets 40 results in a significant increase in magnetic flux in directions perpendicular to the X and Y axes. Completion of the flux path in this way provides for a higher flux-to-mass ratio for the magnet array 20 without the need for heavy magnetically permeable backings.

The polarities of the transverse and wedge magnets 40, 42 are shown by arrows on the magnets in FIGS. 3 and 7. Wedge magnets 42 in the interior wedge magnet groups 46 have identical shapes. Their polarities are at approximately a 45 degree angle with respect to the Z axis. The wedge magnets 42 in the corner magnet group 50 have similar relationships; the polarization of the wedge magnet is at approximately a 45 degree angle with respect to the Z axis.

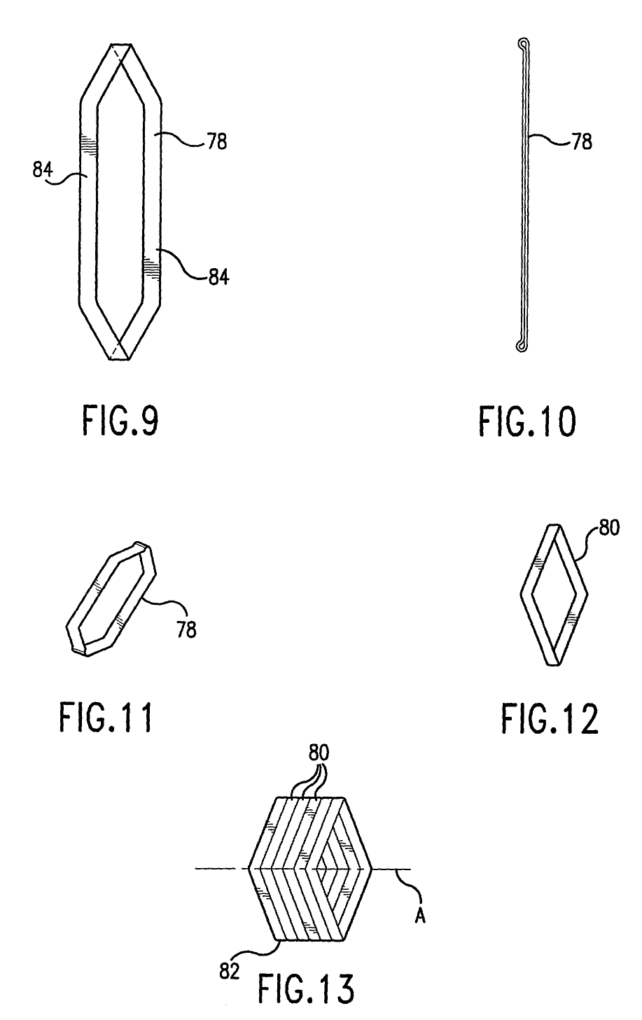

FIG. 8 shows an alternative embodiment of the magnet array 20 of FIG. 3. The magnet array 60 differs from the magnet array 20 of the previous embodiment in that the magnet arrangement results in the same polarity in rows and columns rather than along diagonals as in the first embodiment 20. The magnet array 60 is two sided as described above for the first embodiment 20. Each of the magnet groups includes wedge magnets 51. For example, interior wedge magnet group 52 has four wedge magnets 51. A transverse magnet 54 is interposed between adjacent wedge magnet groups. Exterior edge wedge magnet groups each have two wedge magnets 51 and the exterior corner wedge magnet groups each have only one wedge magnet. The magnet array 60 is preferably used with a linear coil array 64 as shown in FIG. 15 and described below with reference to FIGS. 9-15.

An apparatus and method for making the coils shown in FIGS. 9-15 are described in U.S. patent application Ser. No. 09/059,056, by Hazelton et al., filed Apr. 10, 1998, and incorporated herein by reference. The coil array comprises a plurality of hexagonal shaped coils 78 (FIGS. 9-11). The coil may have shapes other than hexagonal, including diamond 80 (as shown in FIGS. 12-15), double diamond, and parallelogram, for example.

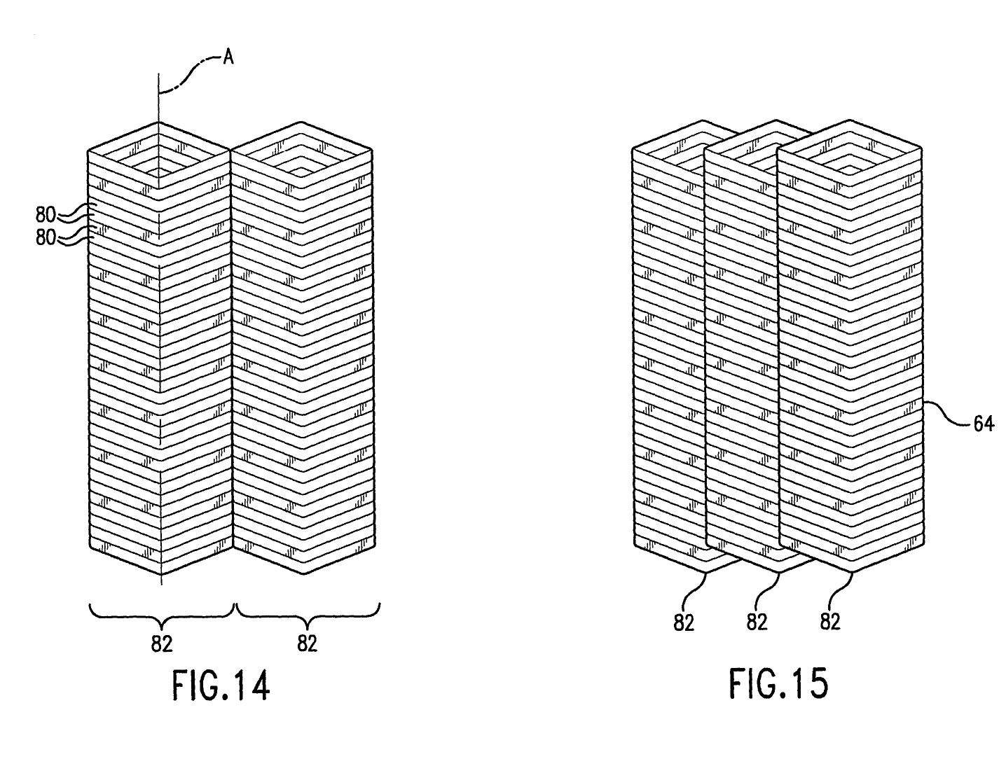

In order to construct a linear coil array 64, a row 82 of partially overlapped coils is first assembled parallel to a longitudinal axis A, as shown in FIG. 13. The row 82 includes six coils 80, two coils for each of three phases. The number of coils 80 in a row 82 may vary, depending on the number of phases of the motor and the choice of coils per phase. Each phase of one row 82 is driven by a separate amplifier of a commutation circuit (not shown). Each linear coil array 64 includes a plurality of rows 82. FIG. 14 shows one arrangement of rows 82. The rows 82 of coils 80 are arranged side-by-side in a lateral direction non-collinear with the longitudinal axis A. Preferably coil assemblies are arranged side-by-side in a direction orthogonal to the longitudinal axis A. FIG. 15 shows another type of arrangement of rows 82. Three coil rows 82 are overlapped side-by-side to form a laterally overlapped linear coil array 64. The coil row 82 should be as long as the required travel of the stage 12 plus the length of the stage.

The linear coil array 64 is positioned on opposite sides of the magnet array. Further details of the positioning of the linear coil array 64 are described in U.S. Pat. No. 6,097,114, entitled “Compact Planar Motor Having Multiple Degrees of Freedom,” issued on Aug. 1, 2000. The number of coils in a row, the number of rows, and arrangement of rows may be different than those shown herein.

It is to be understood that the magnet array 20, 60, coil arrays 14, 16, 64, and arrangement of the magnet array and coil arrays may be different than shown herein without departing from the scope of the invention. For example, the magnet array 20 may include a plurality of magnets having alternating polarities extending along only one axis, as described in U.S. patent application Ser. No. 09/192,813, referenced above.

The bottom and top plates 34, 66 are preferably both made of a magnetically permeable material such as silicon steel so that the gap between the magnet array 20 and the top plate, and between the magnet array 20 and the bottom plate can be adjusted such that the sum of the forces due to the magnet array attraction and the weight of the stage 12 is zero at its nominal operating position. This results in no current, and consequently no power being required to support the stage 12 at its nominal position.

Since the motor 10 is preferably capable of providing six degrees of movement between the stage 12 and the bottom or top plate 34, 66 there are a number of options for driving the stage. The preferred method for driving the stage 12 is to use the upper coil array 14 to drive the stage in six degrees of freedom, while the lower coil array 16 is only used to provide force in the X and Y directions, thus simplifying control of the entire system. It is to be understood however, that control arrangements other than the one described herein can be used without departing from the scope of the invention. For example, both coil arrays 14, 16 can be used with the magnet array 20 to drive the stage 12 in six degrees of movement, or one coil array can drive the stage in three degrees and the other coil array can drive the stage in the other three degrees of movement.

Also, a bearing system may be used to provide one or more of the degrees of movement. The motor 10 may include an air bearing separating one or both of the coil arrays 14, 16 and the magnet array 20. When an air bearing separates the coil arrays 14, 16 and the magnet array 20, the coil array or the magnet array may be potted with any suitable material, such as with epoxy, or covered by a flat plate made of, for example, ceramic, composite or metal, to form essentially flat surfaces. The essentially flat surfaces improve performance of the air bearing in separating or levitating the coil array and magnet array relative to one another.

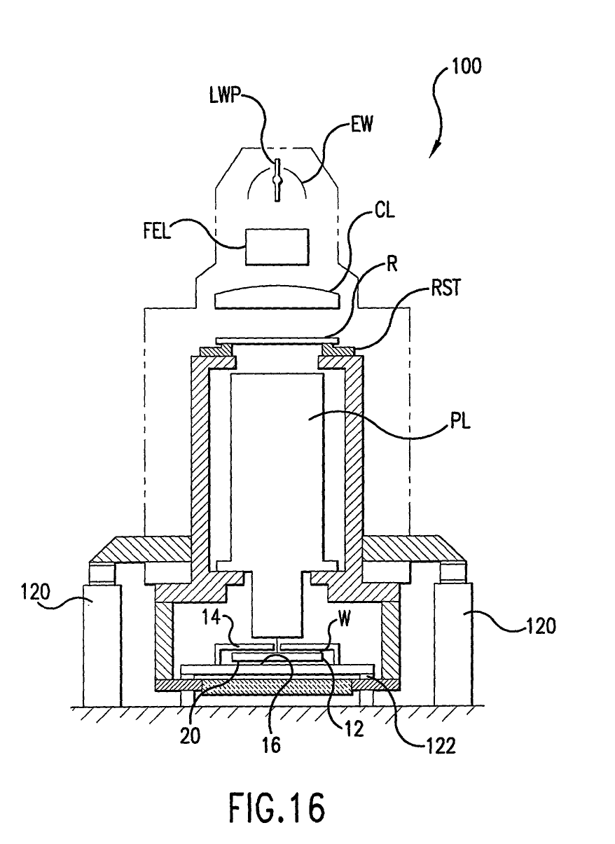

FIG. 16 schematically illustrates an example of a lithography system 100 using the planar motor 10 of the present invention. Examples of photolithography instruments that may incorporate the motor of the present invention are described in U.S. Pat. Nos. 5,623,853, 5,773,837, 5,715,037, and 5,528,118, all of which are incorporated herein by reference. The lithography system 100 generally comprises an illumination system and the motor 10, and the stage 12 for wafer W support and positioning. The illumination system projects light through a mask pattern (e.g., a circuit pattern for a semiconductor device on a reticle R which is supported by and scanned using a stage. The light exposes the mask pattern on a layer of photoresist on the wafer W. The optical system (irradiating system) includes an illuminator having a lamp LMP and an ellipsoid mirror EM surrounding the lamp. The illuminator comprises an optical integrator FEL producing secondary light source images and a condenser lens CL for illuminating the mask R with uniform light flux. A mask holder RST for holding the mask R is mounted above a lens barrel PL on a part of a column assembly which is supported on a plurality of rigid arms 120. The wafer W is shown supported on a support plate (upper surface of the stage 12). The magnet array 20 is attached to the stage 12 and the upper and lower coil arrays 14, 16 are attached to a frame 122. It is to be understood that the lithography system may be different than the one shown herein without departing from the scope of the invention.

The photolithography system 100 shown in FIG. 16 may be a scanning photolithography system, wherein a mask pattern is exposed while the mask and wafer are moved synchronously, or a step-and-repeat photolithography system, wherein a mask pattern is exposed while the mask and wafer are stationary, and the wafer steps in succession, for example. The invention is also applicable to a proximity photolithography system, wherein the mask and wafer are closely located, and exposure of the mask pattern is performed without a projection system. The motor 10 described herein may also be used to drive a reticle stage.

Furthermore, application of the photolithography system is not limited to a photolithography system for semiconductor manufacturing. The system has many uses such as an LCD photolithography system for exposing LCD device patterns onto a rectangular glass plate or a photolithography system for manufacturing a thin film magnetic head, for example.

In terms of the light source for the photolithography system, a g-line (436 rim), i-line (365 am), KrF excimer laser (248 nm), ArF excimer laser (193 nm), F2 laser (157 nm) or X-ray may be used or charged particle beams such as an electron beam, for example. In the case of an electron beam, thermionic emission type lanthanum hexaboride (LaB₆) or tantalum (Ta) may be used as an electron gun.

Reaction forces generated by wafer stage motion may be mechanically released to the floor (ground) using a frame member as described in U.S. Pat. No. 5,528,118. Reaction force generated by reticle stage motion may be released to the floor (ground) using a frame member as described in U.S. Pat. No. 5,874,820, entitled “Window Frame Guided Stage Mechanism.”

As described above, the photolithography system of the present invention can be built by assembling various subsystems, in the manner that prescribed mechanical accuracy, electrical accuracy and optical accuracy are maintained. Examples of the subsystems are the illumination system, optical system (irradiation system), reticle stage, and wafer stage.

In order to maintain accuracy of various subsystems, every subsystem is adjusted to achieve its optical accuracy, mechanical accuracy, and electrical accuracy before and after its assembly. The process of assembling each subsystem into a photolithography system includes mechanical interface, electrical wiring connections, and air pressure plumbing connections. Once the photolithography system is assembled with various subsystems, total adjustment is performed so as to ensure that every accuracy is maintained in a complete system. It is desirable to manufacture the photolithography system in a clean room where the temperature and cleanliness are controlled, as is well known by those skilled in the art.

When the present invention is applied to manufacturing a semiconductor device, such device is fabricated by going through the following steps, for example: design of the device's function and performance; reticle design; manufacturing of the wafer from a silicon material; exposure of a reticle pattern on a wafer by the photolithography system; assembly of the device (including a dicing process, bonding process and packaging process); and inspection and testing of the semiconductor device.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A magnet array for use in a planar motor having two opposing coil arrays; the magnet array having an upper surface and a lower surface and comprising a plurality of wedge magnets disposed in a plane, each wedge magnet having a magnetic polarity oriented at an angle relative to said plane, the magnets being arranged in groups, each group forming an upper resultant magnetic flux extending substantially perpendicular to said plane from said upper surface of the magnet array and a lower resultant magnetic flux extending substantially perpendicular to said plane from said lower surface of the magnet array.

2. The magnet array of claim 1 wherein said wedge magnet group comprises two wedge magnets positioned along the upper surface of the magnet array and two wedge magnets positioned along the lower surface of the magnet array.

3. The magnet array of claim 1 wherein each wedge magnet has a magnetic polarity oriented at an angle perpendicular to said plane.

4. The magnet array of claim 1 wherein the upper resultant magnetic flux and the lower resultant magnetic flux of the wedge magnet group are oppositely directed.

5. The magnet array of claim 1 wherein a sum of an attractive force of the upper resultant magnetic flux, an attractive force of the lower resultant magnetic flux, and a weight of a stage can be adjusted to zero at a nominal operating position of the stage.

6. The magnet array of claim 1, further comprising:
a magnetically permeable top plate to which the upper coil array is adjustably mounted such that a gap between the upper coil array and the top plate can be adjusted;
a magnetically permeable bottom plate to which the lower coil array is adjustably mounted such that a gap between the lower coil array and the bottom plate can be adjusted;
wherein the gaps can be adjusted to set to zero at the nominal operating position a sum of an attractive force of the upper resultant magnetic flux, an attractive force of the lower resultant magnetic flux, and a weight of a stage.

7. The magnet array of claim 1 wherein each wedge magnet group comprises four wedge magnets positioned along the upper surface of the magnet array and four wedge magnets positioned along the lower surface of the magnet array.

8. The magnet array of claim 1 further comprising a plurality of transverse magnets each having a polarity oriented parallel to said plane, at least one transverse magnet being disposed between adjacent wedge magnet groups.

9. The magnet array of claim 8 wherein each transverse magnet and adjacent wedge magnet groups form an upper continuous magnetic flux path and a lower continuous magnetic flux path.

10. An electric motor comprising:
an upper coil array;
a lower coil array; and
a magnet array movable relative to the upper and lower coil arrays and interposed therebetween, the magnet array having an upper surface and a lower surface and comprising a plurality of wedge magnets disposed in a plane, each wedge magnet having a magnetic polarity oriented at an angle relative to said plane, the magnets being arranged in groups, each group forming an upper resultant magnetic flux extending substantially perpendicular to said plane from said upper surface of the magnet array and a lower resultant magnetic flux extending substantially perpendicular to said plane from said lower surface of the magnet array;
the upper coil array being operable to interact with said upper resultant magnetic flux and the lower coil array being operable to interact with said lower resultant magnetic flux to move the magnet array relative to the coil arrays.

11. The electric motor of claim 10 wherein a sum of an attractive force of the upper resultant magnetic flux, an attractive force of the lower resultant magnetic flux, and a weight of a stage can be adjusted to zero at a nominal operating position of the stage.

12. The electric motor of claim 10, further comprising:
a magnetically permeable top plate to which the upper coil array is adjustably mounted such that a gap between the upper coil array and the top plate can be adjusted;
a magnetically permeable bottom plate to which the lower coil array is adjustably mounted such that a gap between the lower coil array and the bottom plate can be adjusted;
wherein the gaps can be adjusted to set to zero at the nominal operating position a sum of an attractive force of the upper resultant magnetic flux, an attractive force of the lower resultant magnetic flux, and a weight of a stage.

13. The electric motor of claim 10 wherein said wedge magnet group comprises two wedge magnets positioned along the upper surface of the magnet array and two wedge magnets positioned along the lower surface of the magnet array.

14. The electric motor of claim 10 wherein the upper resultant magnetic flux and the lower resultant magnetic flux of the wedge magnet group are oppositely directed.

15. The electric motor of claim 10 wherein each wedge magnet group comprises four wedge magnets positioned along the upper surface of the magnet array and four wedge magnets positioned along the lower surface of the magnet array.

16. The electric motor of claim 10 further comprising a plurality of transverse magnets each having a polarity oriented parallel to said plane, at least one transverse magnet being disposed between adjacent wedge magnet groups.

17. The electric motor of claim 16 wherein each transverse magnet and adjacent wedge magnet groups form an upper continuous magnetic flux path and a lower continuous magnetic flux path.

18. The electric motor of claim 10 wherein the upper and lower coil arrays comprise a plurality of coils each having a toroidal shape.

19. The electric motor of claim 10 wherein one of the upper and lower coil arrays has an opening formed therein.

20. An exposure apparatus comprising:
an irradiation system for irradiating an article with radiation to form a pattern on the article; and
a stage positioning device for positioning the article relative to the irradiation system, the stage positioning device comprising:
a stage movable relative to the irradiation system and adapted for supporting the article;
an upper coil array;
a lower coil array; and
a magnet array attached to the stage, the magnet array having an upper surface and a lower surface and comprising a plurality of wedge magnets disposed in a plane, each wedge magnet having a magnetic polarity oriented at an angle relative to said plane, the magnets being arranged in groups, each group forming an upper resultant magnetic flux extending substantially perpendicular to said plane from said upper surface of the magnet array and a lower resultant magnetic flux extending substantially perpendicular to said plane from said lower surface of the magnet array;
the magnet array and stage being interposed between the upper and lower coil arrays, the upper coil array being operable to interact with said upper resultant magnetic flux and the lower coil array being operable to interact with said lower resultant magnetic flux to move the stage relative to the upper and lower coil arrays.

21. The exposure apparatus of claim 20 wherein a sum of an attractive force of the upper resultant magnetic flux, an attractive force of the lower resultant magnetic flux, and a weight of the stage can be adjusted to zero at a nominal operating position of the stage.

22. The exposure apparatus of claim 21, further comprising:
a magnetically permeable top plate to which the upper coil array is adjustably mounted such that a gap between the upper coil array and the top plate can be adjusted;
a magnetically permeable bottom plate to which the lower coil array is adjustably mounted such that a gap between the lower coil array and the bottom plate can be adjusted;
wherein the gaps can be adjusted to set to zero at the nominal operating position a sum of an attractive force of the upper resultant magnetic flux, an attractive force of the lower resultant magnetic flux, and a weight of a stage.

23. The exposure apparatus of claim 20 wherein said wedge magnet group comprises two wedge magnets positioned along the upper surface of the magnet array and two wedge magnets positioned along the lower surface of the magnet array.

24. The exposure apparatus of claim 20 wherein the upper resultant magnetic flux and the lower resultant magnetic flux of the wedge magnet group are oppositely directed.

25. The exposure apparatus of claim 20 wherein each wedge magnet group comprises four wedge magnets positioned along the upper surface of the magnet array and four wedge magnets positioned along the lower surface of the magnet array.

26. The exposure apparatus of claim 20 further comprising a plurality of transverse magnets each having a polarity oriented parallel to said plane, at least one transverse magnet being disposed between adjacent wedge magnet groups.

27. The exposure apparatus of claim 20 wherein each transverse magnet and adjacent wedge magnet groups form an upper continuous magnetic flux path and a lower continuous magnetic flux path.

28. The exposure apparatus of claim 20 wherein the upper and lower coil arrays comprise a plurality of coils each having a toroidal shape.

29. The electric motor of claim 20 wherein one of the upper and lower coil arrays has an opening formed therein.
